(19) United States
(12) Patent Application Publication
(10) Pub. No.: US 2007/0093568 A1
(43) Pub. Date: Apr. 26, 2007

(54) Organic polymer materials having sulfonic acid groups and method for their preparation

(76) Inventor: Makoto Komatsu, Fujisawa-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/557,468

(22) PCT Filed: May 25, 2004
(86) PCT No.: PCT/JP04/07462

§ 371 Date: Oct. 20, 2006

(30) Foreign Application Priority Data
May 27, 2003 (JP) 2003-148568
Mar. 9, 2004 (JP) 2004-065108

(51) Int. Cl. C08J 3/28

(52) U.S. Cl. 522/127

(57) ABSTRACT

The present invention provides a method for preparing an organic polymer material having sulfonic acid groups, which comprises graft-polymerizing to an organic polymer substrate a polymerizable monomer having a benzene ring moiety and also having a vinyl group and a sulfonic acid group in the form of ammonium salt or lithium salt or in the form of sulfonate ester on the benzene ring. According to the method of the present invention, it is also possible to obtain an organic polymer material having polymer side chains formed on the backbone of an organic polymer substrate, wherein said polymer side chains include benzene ring moieties and have sulfonic acid groups on the benzene ring as the only active functional groups and wherein said sulfonic acid groups are attached at the same substitution position on each benzene ring in the polymer side chains.

### TECHNICAL FIELD

The present invention relates to a method for preparing organic polymer materials having sulfonic acid groups, as well as the organic polymer materials prepared by the method.

### BACKGROUND ART

Organic polymer materials having sulfonic acid groups are used in a wide variety of fields. In particular, their potential applications are expanding in the fields of new technologies. Namely, organic polymer materials having sulfonic acid groups allow the introduction of various functions, including hydrophilicity, stain-resistance, and proton conductivity by the action of a sulfonic acid group which serves as a strongly acidic cation-exchange group. Due to their capacity for various functions, organic polymer materials having sulfonic acid groups have a very wide variety of applications, for example, ranging from antistatic films to secondary battery separators. In particular, secondary batteries are now widely developed for practical use, e.g., as batteries for portable/mobile information devices such as mobile telephones or the like, or as batteries for hybrid cars or EVs. In recent years, they have also been expected particularly for use as electrolyte membrane materials for polymer electrolyte fuel cells (PEFC). Thus, with the increase in demand for such technologies, there will be a rapid increase in demand for organic polymer materials having sulfonic acid groups.

To date, two types of strategies have been primarily employed to prepare organic polymer materials having sulfonic acid groups. The first strategy involves polymerization or condensation of polymerizable monomers having a sulfonic acid group to form a polymer and subsequent molding of the polymer thus formed. By way of example, a technique has been proposed in which a diamine having a sulfonic acid group is used as such a monomer and subjected to condensation polymerization to prepare a polyimide containing sulfonic acid groups. The polyimide thus prepared can be used as an electrolyte membrane. However, polyimide electrolyte membranes obtained by such a technique have been associated with problems, such as low proton conductivity or low water-resistance due to high hydrolyzability of imide rings. Also, since the thus prepared polymers having sulfonic acid groups should be molded after polymerization, there is a possibility that polymer moldability may be decreased due to the presence of pendant sulfonic acid groups. For this reason, the first strategy may have a problem in that molded polymer products are high in cost or that the molecular structure of monomers to be used becomes more complex and hence monomers per se becomes high in cost when pursuing the moldability and physical properties of the resulting polymers.

As a second strategy to prepare organic polymer materials having sulfonic acid groups, a technique is employed in which an organic polymer material which has been already molded is used as a substrate and treated to introduce sulfonic acid groups thereinto. Organic polymer substrates preferred for use in such a technique are made of polyolefins represented by polyethylene and polypropylene or fluorinated polyolefins, which are excellent in chemical resistance (e.g., alkali resistance, oxidation resistance).

Introduction of sulfonic acid groups into such an organic polymer substrate may be accomplished, for example, by direct sulfonation of the substrate using a sulfonating agent such as fuming sulfuric acid, chlorosulfonic acid or sulfuric anhydride gas (sulfur trioxide). Among these, sulfonation using sulfur trioxide is particularly available for common use because even hydrophobic polyolefins can be sulfonated with relative ease. However, with this technique it is difficult to ensure uniform introduction of sulfonic acid groups into the substrate, and it may often cause a loss of substrate strength due to the sulfonation treatment. Moreover, sulfonating agents being dangerous drugs are associated with problems, e.g., in terms of safety and environmental load during sulfonation processes, as well as a problem of high cost arising from the need for waste liquid treatment. Further, since direct sulfonation of molded organic polymer substrates requires the use of a particularly reactive sulfonating agent, there is also a problem that it is impossible to avoid side reactions caused by the sulfonating agent and also impossible to obtain materials having sulfonic acid groups introduced in a completely pure form.

Graft polymerization is known as an alternative technique for introduction of sulfonic acid groups into molded organic polymer substrates. In particular, radiation-induced graft polymerization is extremely useful for general purposes because it ensures uniform introduction of sulfonic acid groups into substrates and can also be applied to chemically stable substrates made of polyolefins or fluorinated polyolefins. Further, this graft polymerization technique is relatively less likely to cause a loss of substrate strength as observed in direct sulfonation mentioned above. To introduce sulfonic acid groups into an organic polymer substrate which has been already molded by radiation-induced graft polymerization, a compound that carries both a group having a polymerizable double bond and a sulfonic acid group may be used as a graft monomer and graft-polymerized onto the polymer backbone of the substrate. Conventionally, sodium styrenesulfonate has been used as a graft monomer for this purpose in terms of availability and cost. However, because of its low reactivity, sodium styrenesulfonate is almost impossible to graft-polymerize by itself. For this reason, sodium styrenesulfonate and an easily polymerizable graft monomer (e.g., acrylic acid) have been conventionally used in combination for graft polymerization onto an irradiated organic polymer substrate to introduce sulfonic acid groups into the substrate. However, this technique was not suitable for applications where high durability was required because not only sulfonic acid groups but also carboxyl groups were introduced into the substrate, causing reduction of heat resistance and/or oxidation resistance in the resulting material due to the presence of carboxyl groups. In particular, when intended as a separator for secondary batteries or an electrolyte membrane for polymer electrolyte fuel cells, the grafted material thus prepared was difficult to use for those purposes due to the risk of reduced membrane quality caused by self-discharge. Thus, although it is ideal to ensure exclusive introduction of sulfonic acid groups into a substrate, sodium styrenesulfonate is incapable of graft polymerization by itself, as stated above. To introduce sulfonic acid groups as the only functional groups into an organic polymer substrate, for example, a technique has been proposed in which a monomer free from sulfonic acid groups (e.g., styrene) is first graft-polymerized onto the organic polymer substrate, and the grafted pendant groups thus formed are then treated with a sulfonating agent to introduce sulfonic acid groups into the substrate. However, as in the case of direct sulfonation mentioned above, this technique causes side reactions during sulfonation processes and hence it is difficult to obtain materials having sulfonic acid groups introduced in a completely pure form. This technique therefore has problems with chemical stability of the resulting materials, etc. For example, when the grafted material thus prepared is immersed for a long time (e.g., for a period of several days or longer) in an organic solvent inert to the substrate, it will cause a phenomenon in which the grafted material gradually becomes colored and, in turn, the organic solvent also becomes colored by eluted substances from the grafted material. Such a material is difficult to use for applications where high durability is required. Moreover, since this technique requires the use of a sulfonating agent, there are also problems, e.g., in terms of safety and environmental load during sulfonation processes, as well as a problem of high cost arising from the need for waste liquid treatment, as in the case of direct sulfonation mentioned above.

The following prior art references may be referred: Japanese Patent Public Disclosure No. Hei 6-142439; Japanese Patent Public Disclosure No. 2002-226514; Japanese Patent Public Disclosure No. Hei 11-300171; Japanese Patent Domestic Announcement No. 2001-515113.

### DISCLOSURE OF THE INVENTION

As stated above, among the conventional strategies to prepare organic polymer materials having sulfonic acid groups, in the case of the strategy involving polymerization of monomers having a sulfonic acid group to form a polymer having sulfonic acid groups and subsequent molding of the polymer thus formed, there has been a problem of moldability, as well as a problem that the molecular structure of monomers to be used increases in complexity and hence monomers per se are high in cost when pursuing the moldability and physical properties of the resulting polymer. On the other hand, in the case of another strategy in which a substrate which has been already molded is treated to introduce sulfonic acid groups, it has been difficult to ensure exclusive introduction of sulfonic acid groups in a pure form as the only active functional groups while maintaining the chemical stability or other properties of the substrate material.

The object of the present invention is to overcome the problems of conventional techniques as stated above and to provide a method for preparing an organic polymer material having sulfonic acid groups introduced in a pure form and retaining sufficient chemical stability even with long-term use.

### DETAILED EXPLANATION OF THE INVENTION

As a result of extensive and intensive efforts made to overcome the problems stated above, the inventors of the present invention have found that among polymerizable monomers carrying a polymerizable vinyl-containing group and a sulfonic acid group on their benzene ring (e.g., styrenesulfonic acid), those in which the sulfonic acid group is in the form of ammonium salt or lithium salt or in the form of sulfonate ester are highly reactive and are also capable of graft polymerization by themselves, unlike sodium styrenesulfonate conventionally used as a graft monomer having a sulfonic acid group. Using such monomers for graft polymerization, it has also been found that sulfonic acid groups can be introduced in a pure form as the only active functional groups into an organic polymer substrate. These findings led to the completion of the present invention. Namely, one aspect of the present invention relates to a method for preparing an organic polymer material having sulfonic acid groups, which comprises graft-polymerizing to an organic polymer substrate a polymerizable monomer having a benzene ring moiety and also having a vinyl group and a sulfonic acid group in the form of ammonium salt or lithium salt or in the form of sulfonate ester on the benzene ring. This method enables formation of polymer side chains (graft chains) having sulfonic acid groups on the organic polymer substrate. In the organic polymer material thus prepared, sulfonic acid groups are located on the polymer side chains (graft chains) in the form of lithium salt or ammonium salt or in the form of sulfonate ester. These sulfonic acid groups in the form of lithium salt or ammonium salt may readily be converted into free sulfonic acid form by immersing the resulting organic polymer material in an acid solution and then washing the same with pure water. Likewise, sulfonic acid groups in the form of sulfonate ester may readily be converted into free sulfonic acid form by hydrolyzing the resulting organic polymer material with an aqueous alkaline solution and then immersing the same in an acid solution, or alternatively, by hydrolyzing the resulting organic polymer material with an aqueous acid solution and then washing the same with pure water.

In the present invention, an organic polymer substrate into which sulfonic acid groups are to be introduced is preferably a material excellent in chemical resistance (e.g., alkali resistance, oxidation resistance). Particularly preferred are polyolefins represented by polyethylene and polypropylene or other materials such as fluorinated polyolefins and polyethylene terephthalate, etc. The shape of such a substrate is preferably a fiber material (e.g., woven or non-woven fabric) or a porous membrane. In a case where a fiber material is used as a substrate, the material may consist of monofilaments of made of a single polymer; or alternatively, it may be composed of composite fiber having the core and the sheath made of different polymers.

Graft polymerization, particularly radiation-induced graft polymerization, is preferred for introduction of sulfonic acid groups into the above organic polymer substrate by addition of a polymerizable monomer carrying a vinyl group and a sulfonic acid group in the form of ammonium salt or lithium salt or a sulfonate ester group on its benzene ring. Radiation-induced graft polymerization is a technique allowing the introduction of desired graft polymer side chains (graft chains) into an organic polymer substrate, which involves irradiation of the substrate to generate radicals and subsequent reaction between the radicals and graft monomers. This technique is most preferred for the purpose of the present invention because the number and length of graft chains can be controlled relatively freely and polymer side chains can be introduced into any existing polymer materials of various shapes.

In radiation-induced graft polymerization preferred for the purpose of the present invention, examples of radiation rays available for use include α-ray, β-ray, γ-ray, electron beam and ultraviolet ray, with γ-ray and electron beam being preferred for use in the present invention. There are two types of procedures for radiation-induced graft polymerization: pre-irradiation graft polymerization in which a substrate to be grafted is pre-irradiated and then contacted and reacted with polymerizable monomers (graft monomers); and co-irradiation graft polymerization in which a substrate is irradiated in the presence of monomers. Both of these procedures may be used in the present invention. Also, depending on how to ensure contact between monomers and a substrate, these procedures are further categorized as follows: liquid phase graft polymerization which is performed on a substrate under immersion in a monomer solution; gas phase graft polymerization which is performed on a substrate in the presence of a monomer vapor; and immersion/gas phase graft polymerization in which a substrate is pre-immersed in a monomer solution and then reacted in gas phase after being taken out from the monomer solution. Each procedure may be used in the present invention.

Woven/non-woven fabric that is an assembly of fibers or composite fibers, is the most suitable material for use as an organic polymer substrate to prepare the organic polymer material of the present invention. This material is suitable for use in immersion/gas phase graft polymerization because it is more likely to hold a monomer solution.

In the present invention, an ammonium or lithium salt of styrenesulfonic acid may be listed as a specific example of a compound available for use as a polymerizable monomer having a benzene ring moiety and also having a vinyl group and a sulfonic acid group in the form of ammonium salt or lithium salt on the benzene ring. Sulfonic acid groups in such compounds should be in the form of ammonium salt or lithium salt. In the case of an ammonium salt, an ammonium ion is preferably quaternary ammonium or any of primary to tertiary ammonium ions, and substituents on the nitrogen atom are each preferably a C₁-C₁₀ alkyl group.

In the graft-polymerized product obtained by performing graft polymerization on an organic polymer substrate using the above polymerizable monomer, polymer side chains (graft chains) are formed on the backbone of the substrate and sulfonic acid groups in the form of ammonium salt or lithium salt are present on these polymer side chains (graft chains). To convert these sulfonic acid groups into free acid form, the graft-polymerized material is preferably immersed in an acid solution and then washed with water to remove ammonium ions or lithium ions.

Likewise, in the present invention, a styrenesulfonate ester may be listed as a specific example of a compound available for use as a polymerizable monomer having a benzene ring moiety and also having a vinyl group and a sulfonate ester group on the benzene ring. Sulfonate ester groups in such compounds preferably have a C₁-C₁₀ alkyl group as an ester moiety (i.e., as an alcohol residue), and more preferably have a methyl group, an ethyl group or an isopropyl group.

In the graft-polymerized product obtained by performing graft polymerization on an organic polymer substrate using the above polymerizable monomer, polymer side chains (graft chains) are formed on the backbone of the substrate and sulfonate ester groups are present on these polymer side chains (graft chains). To convert these sulfonate ester groups into free acid form, the graft-polymerized material is preferably hydrolyzed with an aqueous alkaline solution or the like and then immersed in an acid solution; or alternatively, it is preferably hydrolyzed with an acid solution and then washed with pure water.

According to the method of the present invention, it is possible to obtain organic polymer materials having sulfonic acid groups in a pure form as the only functional groups. Namely, such organic polymer materials can retain high chemical stability because they are free from other functional groups (e.g., carboxyl groups) which are responsible for the reduction of heat resistance and/or oxidation resistance, unlike organic polymer materials obtained by graft polymerization using sodium styrenesulfonate in combination with acrylic acid, etc. According to the method of the present invention, it is also possible to overcome the problem of reduced material quality caused by side reactions during sulfonation processes, as observed when a substrate is directly sulfonated or when a substrate is graft polymerized and the grafted side chains are then sulfonated.

According to the method of the present invention, it is further possible to obtain organic polymer materials having sulfonic acid groups, all of which are located at the same substitution position on their polymer side chains (graft chains), i.e., at the same substitution position on each benzene ring in their polymer side chains (graft chains), when using polymerizable monomers having a sulfonic acid group (in the form of ammonium salt or lithium salt or in the form of sulfonate ester group) at the same a single substitution position on the benzene ring (e.g., at the para-position relative to the vinyl group). For example, with conventional procedures where a substrate is graft-polymerized with styrene and the grafted side chains are then sulfonated, it is only possible to prepare an organic polymer material having sulfonic acid groups attached at random substitution positions on the benzene rings in the grafted polymer side chains. Thus, such conventional procedures are substantially incapable of controlling the position where each sulfonic acid group is to be introduced. In addition, one molecule of a sulfonating agent may cause co-sulfonation of two benzene rings during sulfonation processes. This phenomenon causes cross-linking and makes it impossible to avoid a decrease in the flexibility of grafted chains. In contrast, according to the method of the present invention, it is possible to form a polymer having sulfonic acid groups as the only functional groups, all of which are attached at the same substitution position on each benzene ring in the grafted polymer side chains, when using a polymerizable monomer having a sulfonic acid group at a given substitution position. In this way, the method of the present invention not only allows each sulfonic acid group to be located at the same substitution position on each benzene ring in the grafted polymer side chains, but also prevents cross-linking between grafted chains; it is believed that higher functional properties can be achieved with the same amount of functional groups introduced.

The organic polymer materials obtained by the method of the present invention may each be used, for example, as a separator for secondary batteries, an electrolyte membrane for polymer electrolyte fuel cells, a membrane for metal ion removal, etc.

### EXAMPLES

The present invention will be further described in the following examples, which are not intended to limit the scope of the invention. In the following examples, the term “grafting ratio” means an increase in substrate weight (expressed as % by weight) when compared before and after grafting. The units “meq/g-R” and “meq/m²” mean the ion exchange capacity per unit weight of material and the ion exchange capacity per unit area of material, respectively.

### Example 1

While cooling on dry ice, 6.58 g of a non-woven fabric made of polyethylene fibers (a product of DuPont, trade name: Tyvek; average fiber diameter: 0.5 to 10 μm; average pore size: 5 μm; areal density: 63 g/m²; thickness: 0.17 mm) was irradiated with γ-ray at 160 kGy. This irradiated non-woven fabric substrate was impregnated with a solution of p-styrenesulfonic acid lithium salt in ethanol (1:19 by weight), followed by graft polymerization at 60° C. for 3 hours. After the reaction, the non-woven fabric was taken out and washed sequentially with ethanol and pure water. After being wiped, it was dried in a hot air dryer at 50° C. for 3 hours to give a grafted non-woven fabric in the form of styrenesulfonic acid lithium salt (7.04 g) with a grafting ratio of 7.0%.

The resulting grafted non-woven fabric was washed three times with 0.1 mol/L hydrochloric acid (500 mL) and further washed three times with pure water (500 mL) at 60° C. After being wiped, it was dried in a hot air dryer at 50° C. for 3 hours to give a sulfonic acid group-containing non-woven fabric material 1 according to the present invention (7.03 g). The resulting sulfonic acid group-containing non-woven fabric material 1 had an ion exchange capacity of 9.8 meq/m².

### Example 2

Under the same conditions as shown in Example 1, 6.15 g of the same non-woven fabric substrate as used in Example 1 was irradiated with γ-ray. This irradiated substrate was impregnated with an ethyl styrenesulfonate/toluene mixture (1:19 by weight), followed by graft polymerization at 60° C. for 3 hours. After the reaction, the non-woven fabric was taken out and washed three times with dichloromethane (100 mL). After being wiped, it was dried at 50° C. for 3 hours to give an ethyl styrenesulfonate-grafted non-woven fabric (6.68 g) with a grafting ratio of 8.6%.

The resulting ethyl styrenesulfonate-grafted non-woven fabric was immersed in a 0.5 mol/L aqueous sodium hydroxide/ethanol mixture (1:1 by volume) and heated at 80° C. for 6 hours. The non-woven fabric was then taken out and washed sequentially with pure water (500 mL) and 1 mol/L hydrochloric acid (500 mL). It was further washed three times with pure water (500 mL) at 60° C. and wiped, followed by drying in a hot air dryer at 50° C. for 3 hours to give a sulfonic acid group-containing non-woven fabric material 2 according to the present invention (6.61 g). The resulting sulfonic acid group-containing non-woven fabric material 2 had an ion exchange capacity of 22.7 meq/m².

### Comparative Example 1

Under the same conditions as shown in Example 1, 6.46 g of the same non-woven fabric substrate as used in Example 1 was irradiated with γ-ray. This irradiated non-woven fabric substrate was impregnated with a styrene/toluene mixture (1:19 by weight), followed by graft polymerization at 60° C. for 3 hours. After the reaction, the non-woven fabric was taken out and washed three times with dichloromethane (100 mL). After being wiped, it was dried in a hot air dryer at 50° C. for 1 hour to give a styrene-grafted non-woven fabric (6.65 g) with a grafting ratio of 2.9%.

The resulting grafted non-woven fabric was immersed in a chlorosulfonic acid/dichloromethane mixture (2:98 by weight) and sulfonated at 0° C. for 1 hour. After the reaction, the non-woven fabric was taken out, washed sequentially with a methanol/dichloromethane mixture (1:9 by volume, 500 mL) and methanol (500 mL), and further washed three times with pure water (500 mL) at 60° C. After being wiped, it was dried in a hot air dryer at 50° C. for 1 hour to give a sulfonic acid group-containing non-woven fabric material A (6.80 g). The resulting sulfonic acid group-containing non-woven fabric material A had an ion exchange capacity of 16.4 meq/m².

### Example 3

Under the same conditions as shown in Example 1, 1.52 g of a porous membrane (thickness: 100 μm; areal density: 25 g/m²) made of ultra-high molecular weight polyethylene (Average Mn: ca 1,000,000) was irradiated with γ-ray. The irradiated porous membrane substrate was impregnated with a solution of p-styrenesulfonic acid lithium salt in ethanol (5:95 by weight), followed by graft polymerization at 60° C. for 6 hours. After the reaction, the porous membrane was taken out and washed sequentially with ethanol and pure water. After being wiped, it was dried in a hot air dryer at 50° C. for 3 hours to give a grafted porous membrane (1.61 g) in the form of styrenesulfonic acid lithium salt with a grafting ratio of 5.7%.

The resulting grafted porous membrane was washed twice with 0.5 mol/L hydrochloric acid (500 mL) and further washed twice with pure water (500 mL) at 60° C. After being wiped, it was dried in a hot air dryer at 50° C. for 3 hours to give a sulfonic acid group-containing porous membrane 3 according to the present invention (1.60 g). The resulting sulfonic acid group-containing porous membrane 3 had an ion exchange capacity of 5.6 meq/m².

### Comparative Example 2

Under the same conditions as shown in Example 3, 1.51 g of the same porous membrane as used in Example 3 was irradiated with γ-ray. The irradiated porous membrane substrate was impregnated with a styrene/toluene mixture (1:20 by volume), followed by graft polymerization at 60° C. for 3 hours. After the reaction, the porous membrane was taken out and washed twice with dichloromethane (500 mL). After being wiped, it was dried in a hot air dryer at 50° C. for 3 hours to give a styrene-grafted porous membrane (1.58 g) with a grafting ratio of 4.5%.

The resulting grafted porous membrane was immersed in a chlorosulfonic acid/dichloromethane mixture (2:98 by weight) and sulfonated at 0° C. for 1 hour. After the reaction, the porous membrane was taken out, washed sequentially with a methanol/dichloromethane mixture (1:9 by volume, 500 mL) and methanol (500 mL), and further washed twice with pure water (500 mL) at 60° C. After being wiped, it was dried in a hot air dryer at 50° C. for 3 hours to give a sulfonic acid group-containing porous membrane material B (1.63 g). The resulting sulfonic acid group-containing porous membrane material B had an ion exchange capacity of 6.9 meq/m².

### Example 4

While cooling on dry ice, 9.92 g of a non-woven fabric made of polyethylene fibers (fiber diameter: 20 to 30 μm; areal density: 50 to 60 g/m²; a product of Japan Vilene Co., Ltd., product code OX8901T6) was irradiated with γ-ray (160 kGy). This irradiated non-woven fabric substrate was impregnated with a solution of p-styrenesulfonic acid tributylammonium salt in toluene (20:80 by weight), followed by graft polymerization at 60° C. for 6 hours. After the reaction, the non-woven fabric was taken out and washed three times with ethanol (500 mL). After being wiped, it was dried in a hot air dryer at 50° C. for 3 hours to give a grafted non-woven fabric (11.16 g) in the form of styrenesulfonic acid tributylammonium salt with a grafting ratio of 12.5%.

The resulting grafted non-woven fabric was washed twice with 0.5 mol/L hydrochloric acid (500 mL) and further washed twice with pure water (500 mL) at 60° C. After being wiped, it was dried in a hot air dryer at 50° C. for 3 hours to give a sulfonic acid group-containing non-woven fabric material 4 according to the present invention (10.74 g). The resulting sulfonic acid group-containing non-woven fabric material 4 had an ion exchange capacity of 0.235 meq/g-R.

### Example 5

### Experiment of Organic Matter Extraction

The sulfonic acid group-containing non-woven fabric materials 1, 2 and A prepared above were individually cut into 18 pieces (5 cm×5 cm each). The test pieces thus prepared and the organic solvents (250 mL each) listed in Table 1 were placed and sealed in 500 mL Erlenmeyer flasks equipped with stoppers, followed by shaking at 25° C. for 48 hours. The organic solvents were each transferred to a 1 L recovery flask and concentrated on a rotary evaporator to a volume of 2 to 3 mL. Each concentrated solution was transferred to a pre-weighed aluminum evaporating dish. At the same time, the recovery flask used was washed three times with isopropanol (10 mL) and the washing solvent was also collected into the evaporating dish. The evaporating dish was placed in a vacuum dryer and dried under vacuum at 50° C. for about 3 hours. The dried evaporating dish was weighed to determine the amount of extracted matter into the organic solvent. The results obtained are shown in Table 1.

TABLE 1
Results of organic matter extraction in Example 5

| | | | Non-woven fabric |
|---|---|---|---|
| | Non-woven fabric | Non-woven fabric | material A |
| | material 1 | material 2 | (Comparative |
| Solvent | (Example 1) | (Example 2) | Example 1) |
| Isopropanol | <1 mg | <1 mg | 8 mg |
| Acetone | 4 mg | 9 mg | 483 mg |

As shown in Table 1, the non-woven fabric materials from Example 1, Example 2 and Comparative Example 1 were immersed for a long time in the solvents inert to the substrate, confirming that the sulfonic acid group-containing non-woven fabric materials prepared by the method of the present invention caused no elution into the organic solvents and were chemically stable even in long-term immersion in the organic solvents, when compared to the sulfonic acid group-containing non-woven fabric material prepared by conventional styrene grafting and sulfonation techniques. In addition, visual inspection of the immersed non-woven fabric materials indicated that the non-woven fabric material A was discolored brown, whereas the non-woven fabric materials 1 and 2 were resistant to discoloration. This result also proved their chemical stability.

### Example 6

### Water Absorption Test

The sulfonic acid group-containing non-woven fabric materials 1 and A prepared above were individually cut into strips (4 mm×25 mm each). Pure water (80 μL) was introduced into a trough made of acrylic sheet (28 mm in length, 1.5 mm in width, 1.5 mm in depth). The strip test pieces were stood in the trough, such that their lower edge was placed in water with the long side positioned vertically, to monitor changes over time in the height which pure water reached.

As a result, water reached a height of 5 mm after 50 seconds and 10 mm after 190 seconds for the sulfonic acid group-containing non-woven fabric material 1, whereas the position of pure water was not elevated at all for the sulfonic acid group-containing non-woven fabric material A. Thus, it was indicated that the sulfonic acid group-containing non-woven fabric material 1 according to the present invention had higher hydrophilicity although it carried a smaller amount of functional groups. This result may be ascribed to the fact that in the organic polymer materials obtained by the method of the present invention, their sulfonic acid groups are all systematically attached only at the para-position on the benzene ring moieties in the grafted polymer side chains (graft chains). Moreover, the result may also be ascribed to the fact that there is no side reaction to cause, e.g., cross-linking, unlike conventional techniques.

### Example 7

### Chemical Resistance Test (Coloring Test)

The sulfonic acid group-containing porous membrane materials 3 and B prepared above were individually cut into pieces (1 cm×5 cm each), immersed in acetone (10 mL) in test tubes equipped with stoppers, and allowed to stand at room temperature for 20 days. The absorbance was measured with an absorptiometer for each sample after immersion. The results obtained are shown in Table 2.

TABLE 2
Results of Example 7

| | Porous membrane | Porous membrane |
|---|---|---|
| Wavelength (nm) | material 3 | material B |
| 300 | 0.73 | >4.00 |
| 400 | 0.08 | >4.00 |
| 420 | <0.01 | 2.63 |
| 440 | <0.01 | 2.43 |
| 460 | <0.01 | 1.85 |
| 480 | <0.01 | 1.33 |
| 500 | <0.01 | 0.94 |
| 600 | <0.01 | <0.01 |

The results shown in Table 2 indicate that the sulfonic acid group-containing porous membrane material according to the present invention is less discolored and hence excellent in chemical stability in organic solvents such as acetone.

### INDUSTRIAL APPLICABILITY

According to the method of the present invention, in the preparation of organic polymer materials having sulfonic acid groups, it is possible to avoid reduction in substrate quality and side reactions resulting from the use of a sulfonating agent. According to the method of the present invention, it is also possible to obtain organic polymer materials having sulfonic acid groups in a pure form as the only active functional groups, all of which are attached at the same substitution position on each benzene ring moiety in the polymer side chains (graft chains). In view of the above characteristics, the present invention enables the provision of organic polymer materials excellent in chemical stability and functional properties.

1. A method for preparing an organic polymer material having sulfonic acid groups, which comprises graft-polymerizing to an organic polymer substrate a polymerizable monomer having a benzene ring moiety and also having a vinyl group and a sulfonic acid group in the form of ammonium salt or lithium salt on the benzene ring.

2. A method for preparing an organic polymer material having sulfonic acid groups, which comprises graft-polymerizing to an organic polymer substrate a polymerizable monomer having a benzene ring moiety and also having a vinyl group and a sulfonate ester group on the benzene ring.

3. The method according to claim 1, wherein the graft polymerization is conducted via a radiation-induced graft polymerization.

4. The method according to claim 1, wherein the organic polymer substrate is in the form of a woven fabric, a non-woven fabric or a porous membrane.

5. An organic polymer material having polymer side chains formed on the backbone of an organic polymer substrate, wherein said polymer side chains include benzene ring moieties and have sulfonic acid groups on the benzene ring as the only active functional groups and wherein said sulfonic acid groups are attached at the same substitution position on each benzene ring in the polymer side chains.

6. The method according to claim 2, wherein the graft polymerization is conducted via a radiation-induced graft polymerization.

7. The method according to claim 2, wherein the organic polymer substrate is in the form of a woven fabric, a non-woven fabric or a porous membrane.

8. The method according to claim 3, wherein the organic polymer substrate is in the form of a woven fabric, a non-woven fabric or a porous membrane.

9. The method according to claim 6, wherein the organic polymer substrate is in the form of a woven fabric, a non-woven fabric or a porous membrane.
